(19) United States
(12) Patent Application Publication
(10) Pub. No.: US 2016/0098297 A1
(43) Pub. Date: Apr. 7, 2016

(54) System and Method for Determining Capacity in Computer Environments Using Demand Profiles

(71) Applicant: CiRBA Inc., Richmond Hill (CA)

(72) Inventors: Tom YUYITUNG, Toronto (CA); Giampiero DE CIANTIS, Keswick (CA); Mikhail KOUZNETSOV, Maple (CA)

(21) Appl. No.: 14/967,694

(22) Filed: Dec. 14, 2015

Related U.S. Application Data
(63) Continuation of application No. PCT/CA2014/050561, filed on Jun. 16, 2014.
(60) Provisional application No. 61/835,359, filed on Jun. 14, 2013.

(51) Int. Cl. G06F 9/50

(52) U.S. Cl. CPC G06F 9/505; G06F 9/5055

(57) ABSTRACT

A system and method are provided for determining aggregate available capacity for an infrastructure group with existing workloads in computer environment. The method comprises determining one or more workload placements of one or more workload demand entities on one or more capacity entities in the infrastructure group; computing an available capacity and a stranded capacity for each resource for each capacity entity in the infrastructure group, according to the workload placements; and using the available capacity and the stranded capacity for each resource for each capacity entity to determine an aggregate available capacity and a stranded capacity by resource for the infrastructure group.

### CROSS-REFERENCE TO RELATED APPLICATIONS

This application is a continuation of International PCT Application No. PCT/CA2014/050561 filed on Jun. 16, 2015 which claims priority from U.S. Provisional Patent Application No. 61/835,359 filed on Jun. 14, 2013, both incorporated herein by reference.

### TECHNICAL FIELD

The following relates to systems and methods for determining capacity in computer environments using demand profiles.

### DESCRIPTION OF THE RELATED ART

Virtualization is used in computing environments to create virtual versions of, for example, a hardware platform, an operating system (OS), a storage device, a network resource, etc. Virtualization technologies are prevalent in datacenters as they tend to improve manageability and promote more efficient use of resources. Virtualization allows compute, storage and networking resources to be pooled into an infrastructure group or “cluster”.

For example, a cluster may be comprised of multiple host servers that provide compute capacity (CPU, memory). The servers are able to access shared storage capacity (e.g. storage area network, network attached storage, etc.) and are connected to common network resources. In general, the compute capacity is dedicated to the cluster, but the storage and network resources may be shared between multiple clusters.

Workloads in the form of virtual machines (VMs) run on the servers and make use of the connected storage and network resources. Many virtualization technologies support the ability to share resources (e.g. overcommitted CPUs and memory, thin-provisioned storage, etc.) since most workloads do not need all their allocated resources all the time. Furthermore, some virtualization technologies support advanced capabilities such as live migration, automated load balancing and high availability. Live Migration entails moving workloads (VMs) between hosts with no downtime. Automated Load Balancing actively moves workloads between hosts to balance loads within a cluster. High Availability reserves capacity in the cluster to handle a predefined number of host failures, and involves restarting VMs in the event of host failures.

Traditionally, for capacity planning or routing workloads to specific clusters in a datacenter, a measure of available capacity is useful. This typically entails measuring and summing the unused capacity (e.g. CPU, memory, disk space) of each potential resource constraint on each host or storage device in the scope of the infrastructure of interest (e.g. cluster, datacenter). The total unused capacity for each resource can then be converted to a percentage of the total capacity of the resource in the group. The resource with the lowest percentage of available capacity can be considered to be the primary resource constraint. The number of additional workloads that can be deployed in the group can be estimated from a pro-rated value of the current number of workloads and the available capacity of the primary constraint.

For example, consider a group of 10 servers with 200 existing VM workloads where the available capacity based on CPU and memory resources are 30% and 20%, respectively. Memory is the primary constraint since it has the lesser available capacity of the two resource constraints. The additional VM workloads that can be added to the host group can be estimated as follows:

Maximum VM workloads=200VMs*100%/(100%−20%)=250VMs

Additional VMs=Maximum VMs−Current VMs=250−200=50VMs

The additional workloads are therefore based on the average of the existing workloads. Note that this estimate assumes that all unused capacity can be utilized. Alternatively, the available capacity can be adjusted by assuming a safety buffer (e.g. memory usage should not exceed 90%), so the adjusted available capacity will result in a corresponding change in the estimate of the additional VMs.

### SUMMARY

In one aspect, there is provided a method of determining aggregate available capacity for an infrastructure group with existing workloads in computer environment, the method comprising: determining one or more workload placements of one or more workload demand entities on one or more capacity entities in the infrastructure group; computing an available capacity and a stranded capacity for each resource for each capacity entity in the infrastructure group, according to the workload placements; and using the available capacity and the stranded capacity for each resource for each capacity entity to determine an aggregate available capacity and a stranded capacity by resource for the infrastructure group.

In another aspect, there is provided a computer readable storage medium comprising computer executable instructions for determining capacity in computer environments, the computer executable instructions comprising instructions for determining one or more workload placements of one or more workload demand entities on one or more capacity entities in the infrastructure group; computing an available capacity and a stranded capacity for each resource for each capacity entity in the infrastructure group, according to the workload placements; and using the available capacity and the stranded capacity for each resource for each capacity entity to determine an aggregate available capacity and a stranded capacity by resource for the infrastructure group.

In yet another aspect, there is provided an analysis system comprising a processor and memory, the memory comprising computer executable instructions for determining capacity in computer environments, the computer executable instructions comprising instructions for determining one or more workload placements of one or more workload demand entities on one or more capacity entities in the infrastructure group; computing an available capacity and a stranded capacity for each resource for each capacity entity in the infrastructure group, according to the workload placements; and using the available capacity and the stranded capacity for each resource for each capacity entity to determine an aggregate available capacity and a stranded capacity by resource for the infrastructure group.

### BRIEF DESCRIPTION OF THE DRAWINGS

Embodiments will now be described by way of example only with reference to the appended drawings wherein:

FIG. 1 illustrates a virtual compute model;

FIG. 2 illustrates a shared storage model;

FIG. 3 illustrates a workload placement analysis;

FIG. 4 illustrates an aggregate capacity analysis;

FIG. 5 illustrates a demand profile configuration;

FIG. 6 illustrates candidate workloads determined from a set of demand profiles to generate an aggregate demand profile;

FIG. 7 illustrates a determination of available capacity in spare VMs based on aggregate available capacity;

FIG. 8 illustrates a determination of available capacity in spare VMs based on per-host/sensor available capacity;

FIG. 9 illustrates a validation of available capacity and get placements for candidate workloads;

FIG. 10 is a screen shot of an example of a user interface for reviewing and altering policy settings;

FIG. 11 is a screen shot of an example of a user interface for routing workloads to and reserving capacity in infrastructure groups; and

FIG. 12 is an example of an available capacity report.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

The examples and corresponding diagrams used herein are for illustrative purposes only. Different configurations and terminology can be used without departing from the principles expressed herein. For instance, components and modules can be added, deleted, modified, or arranged with differing connections without departing from these principles.

It has been recognized that traditional approaches to measuring available capacity in a computing environment may be incomplete. For example, the above-described approach that uses the total available capacity does not account for stranded capacity or the actual workload placements.

Capacity can be stranded because the pooled resources of an infrastructure group are comprised of discrete capacity entities where there are one or more potential resource constraints. For example, compute capacity is comprised of multiple hosts (i.e. a type of capacity entity), each of which may be constrained by CPU, memory, disk I/O, network I/O, etc. Similarly, storage capacity is comprised of multiple devices (i.e. another type of capacity entity), each of which may be constrained by used space, provisioned space, I/O rates, latency, etc. When one or more resources on a discrete capacity entity are fully consumed by the workloads placed on the capacity entity, the unused resources associated with other resources are stranded.

Moreover, the workload placements (i.e. host and storage capacity entities on which the VMs workload are placed) can affect the available capacity measurement for an infrastructure group. For example, poor workload placements that result in large amounts of stranded capacity will reduce the available capacity. Conversely, optimized workload placements that place the workloads on the minimum number of entities tend to minimize stranded capacity and hence, increase the available capacity.

When measuring the available capacity of a given infrastructure group, different scenarios can be considered. For example, one can consider the case where one assumes the current workload placements. This is useful when it is desired to route workloads to an infrastructure group immediately. Alternatively, one can also consider the case where it is assumed that the workloads have been rebalanced across the entities in the infrastructure group. This is useful when workloads are rebalanced regularly (e.g. nightly) and one needs to estimate available capacity and route workloads in the near term. Finally, one can consider the case where the workload placements have been optimized such that the VMs are placed on the minimum number of hosts. This scenario is useful when it is desired to plan capacity for future time frames where it is reasonable to assume that workload placements are optimized with the infrastructure group over time.

In addition, it has been found that measuring the available capacity of an infrastructure group based on a predefined (and definable) demand profile can be more intuitive for capacity planners who wish to know how many more workloads (e.g. medium sized VMs with specific resource allocations and expected utilization levels) can fit in the environment. Furthermore, the ability to define specific demand profiles allows users to measure available capacity based on the expected resource requirements of the incoming workloads.

The following provides a system and method for determining available capacity in infrastructure groups that accounts for stranded capacity and different workload placement scenarios. The available capacity of an infrastructure group can be determined for each possible resource constraint and can also be expressed in spare VMs based on a given demand profile. The available capacity can be estimated based on the aggregate available capacity or measured more accurately by considering the available capacity on a per-entity (e.g. per-host or per-storage device) basis. Placements for a set of candidate workloads can be confirmed and determined by simulating and reserving the required resources against the available capacity on a per-entity basis.

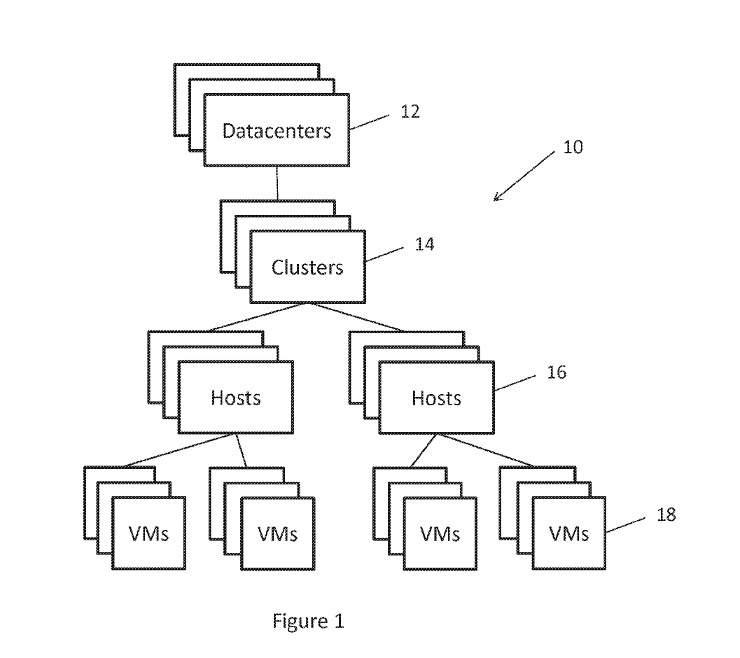

Turning now to the figures, FIG. 1 illustrates an example of a virtual compute model 10. The virtual compute model 10 illustrates that datacenters 12 can include one or more clusters 14 (also referred to as infrastructure groups (IGs)). Clusters 14 include one or more hosts 16 (i.e. compute capacity entities) that provide compute capacity and share resources such as storage and networking. One or more VMs 18 (i.e. workload demand entities) run on a host 16 and VMs can be moved between hosts 16 to balance loads.

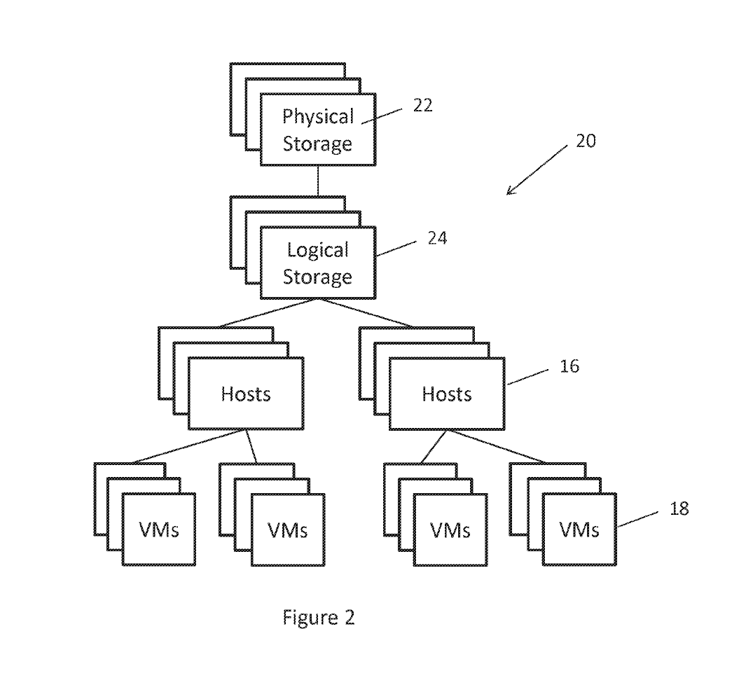

FIG. 2 illustrates an example of a shared storage model 20. Physical storage devices 22 (i.e. a type of storage capacity entity) such as storage arrays host the storage media (e.g. hard disks), controllers and adapters used for storing and accessing the data. Logical storage entities 24 (e.g. volumes or datastores, i.e. another type of storage capacity entity) reside on the physical storage devices 22 and are presented to the hosts 16. In general, hosts within the same infrastructure group have access to a common set of logical storage entities. The VMs 18 running on the hosts store their data on the logical storage entities. Since the hosts in the infrastructure have access to the same set of logical storage entities, VMs moving between hosts in the group retain access to their stored data.

The models 10, 20 in FIGS. 1 and 2 may be considered a virtual environment model collectively. Additional models such as a network resource model comprised of network switches can be added to the virtual environment model.

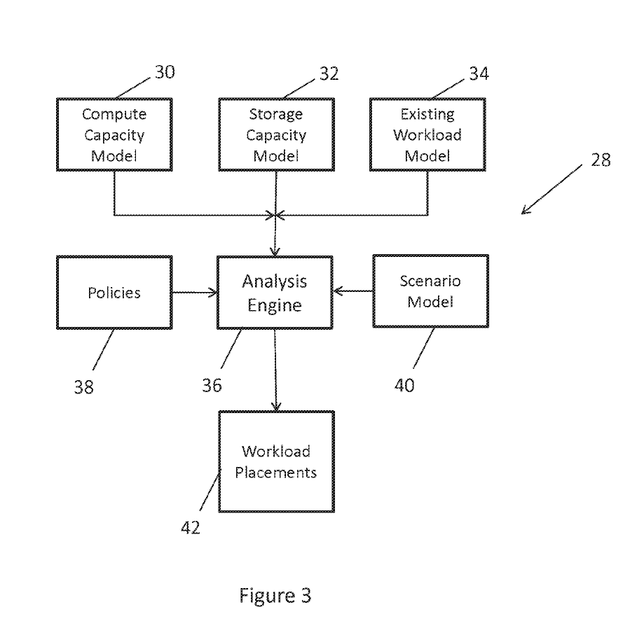

FIG. 3 illustrates an example of a workload placement analysis 28. The workload placement analysis 28 considers a given infrastructure group (aka cluster 14), in this case, comprised of a compute capacity model 30, a storage capacity model 32, and an existing workload model 34.

The compute capacity model 30 is comprised of the hosts in the cluster 14 and describes the capacity of the compute-related resources (e.g. CPU cores, installed memory, disk I/O bandwidth via adapters, network I/O bandwidth via network adapters) that can be consumed by the workloads running on the host 16.

The storage capacity model 32 is comprised of the storage entities (e.g. datastores, volumes, pools, arrays, etc.) that can be accessed by the infrastructure group. This model 32 describes the capacity and metrics of the storage-related resources (e.g. used space, provisioned space, disk I/O bandwidth, disk latency) that can be consumed by the workloads that use of these resources.

The existing workload model 34 represents the VMs currently deployed in the infrastructure group. The model 34 describes the resource allocations and utilization levels of each VM. Resource allocations for VMs include the number of virtual CPUs, CPU reservation, memory allocation, memory reservation, provisioned disk space, reserved disk space, etc. Resource utilization levels include the % CPU utilization, memory usage, disk I/O operations (IOPs), disk I/O throughput (bytes/s), network I/O activity (packets/s), network I/O throughput (bytes/s), disk space usage, etc. Utilization is typically collected and stored as time-series data and can be rolled up to representative models such as daily averages, 95th percentile, hourly quartiles, etc.

The policies 38 allow users to specify criteria for managing the infrastructure group. The policy settings can represent constraints, regulations and operational goals that affect the VM placements, VM density, performance, availability, etc. Examples of policy settings that affect the VM placements and density in an infrastructure group include the high limits for the host CPU utilization (e.g. 70%), host memory utilization (e.g. 90%), datastore disk space usage (e.g. 80%), datastore provisioned space (e.g 200%), vCPU/CPU core overcommit (e.g. 200%), VM memory allocation/physical host memory (e.g. 100%), etc. Other policy settings include such things as the high availability (HA) requirements to handle one or more host failures, criteria for choosing the representative workload levels of the VMs (e.g. assume busiest vs. average), keeping VMs in HA group apart, placing systems with licensed software on specific hosts, modeling growth trends in workload utilization for future time frames, etc.

The scenario model 40 allows the user to specify the use case to be modeled that impact the workload placements. Examples of scenarios include the current placements, rebalanced workload placements and optimized workload placements.

As illustrated in FIG. 3, the analysis engine 36 uses these models 30, 32, 34, 40 and policies 38 to determine the workload placements 42 for the existing VMs in the infrastructure group. The rebalanced workload placements scenario may shift VMs between hosts to balance the workloads while also ensuring that the management criteria defined through the policies are met. The optimized workload placements involve shifting the VMs onto the minimum number of hosts subject to the policies.

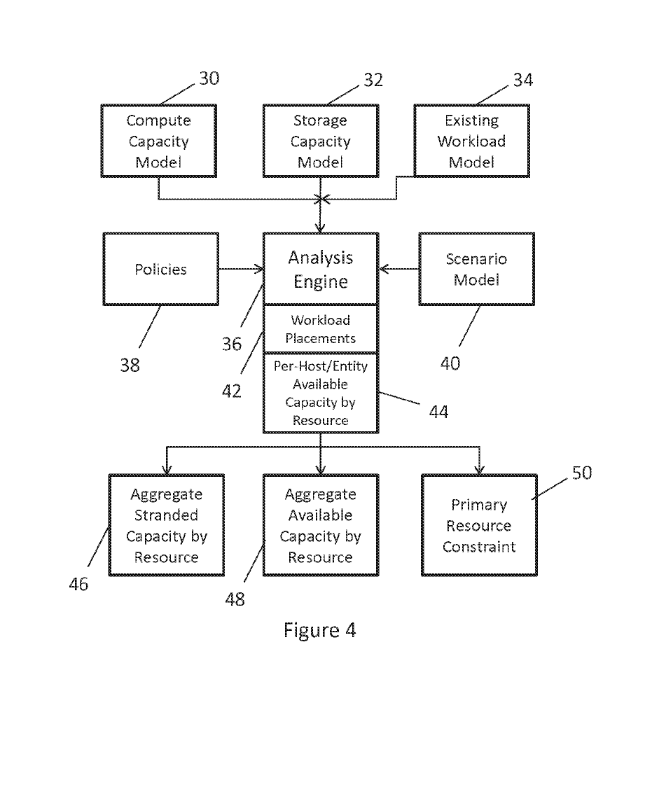

Turning now to FIG. 4, the workload placements 42 determined for an infrastructure group according to the workload placement analysis can be extended to compute the aggregate available capacity for each resource 48 and aggregate stranded capacity for each resource 46.

Given the workload placements 42 for an infrastructure group, these metrics can be computed by first computing the free capacity for each resource (e.g. CPU, memory, disk space, etc.) for each host and storage entity in the group subject to the policies.

If one or more resource is constrained on the host (e.g. CPU usage=75% and is equal to or above the policy limit of 70%), treat all other free capacity of other resources on the host as stranded capacity. Otherwise, if none of the resources are constrained on the host (i.e. resource usage is below policy limit), treat all free resources on the host as available capacity 44.

By analyzing the free capacity on each host and storage entity for each resource based on the policies, and tallying this value as available or stranded capacities by resource across the hosts, the analysis engine 36 computes the aggregate available and stranded capacity for each resource 48, 46 for the infrastructure group.

The aggregate available capacity for each resource can then be computed as a percentage of the total capacity, and the resource with the lowest percentage of available capacity is considered to be the primary resource constraint 50.

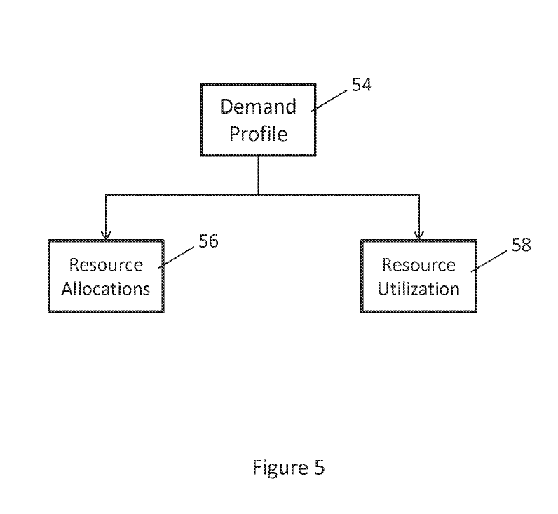

FIG. 5 illustrates an example of a demand profile 54, which is defined by resource allocations 56 (e.g. number of virtual CPUs, memory allocation, disk space allocation, etc.) and resource utilization metrics 58. The resource utilization metrics 58 can include, for example, % CPU usage, % memory usage, disk I/O activity (bytes/s, IOPs), network I/O activity (packets/s, bytes/s), disk space usage, etc. Utilization patterns over time can also be considered, for example, hourly patterns for a representative day.

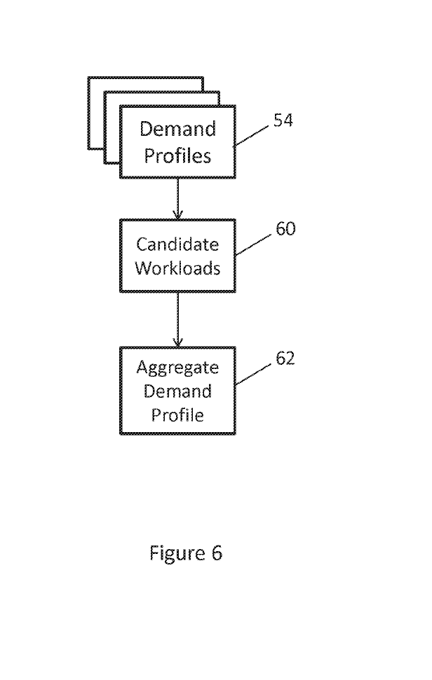

FIG. 6 illustrates candidate workloads 60, which may include multiple demand profiles 54 to represent a set of related workloads (e.g. multi-tier application, project, etc.). The multiple demand profiles 54 can be combined to an aggregate demand profile 62 which is based on the sum of the resource allocations and utilization of the demand profiles that comprise the candidate workloads.

The demand profiles 54 can be used as a unit of measure for modeling how many more VMs 18 can fit into an infrastructure group or cluster 14. A commonly used demand profile 54 can be based on the most common VM workload deployed in the cluster 14. The demand profile 54 therefore describes the allocations and utilization of a sample VM 18.

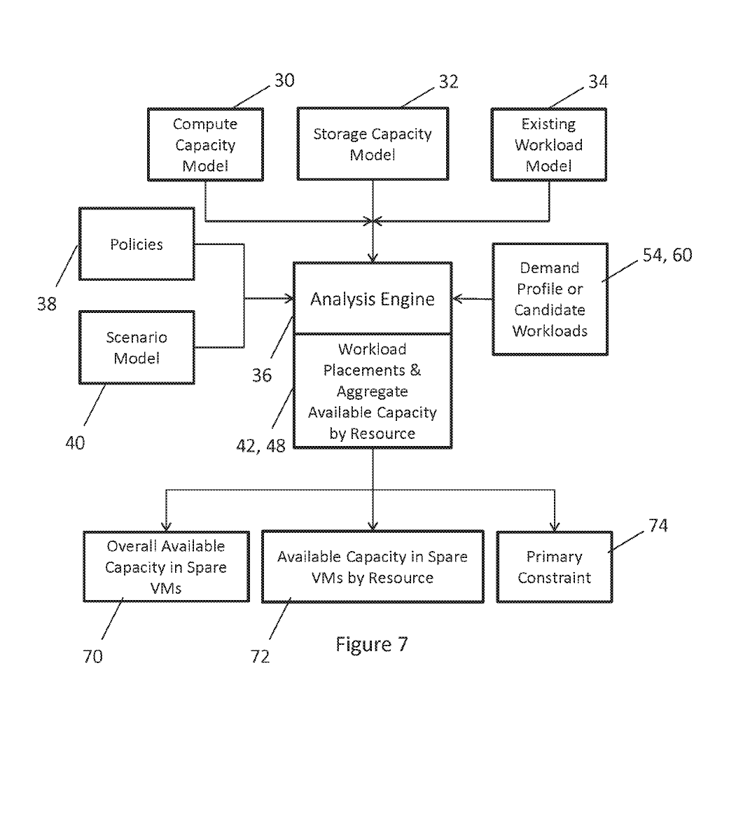

FIG. 7 illustrates how the analysis engine 36 can use the workload placements 42, aggregate available capacity per resource 48 and demand profile 54 or candidate workloads 60 to compute the overall available capacity in spare VMs 70, available capacity in spare VMs by resource 72 and the primary resource constraint 74.

The available capacity in spare VMs for a given resource 72 is computed for a given infrastructure group and demand profile by dividing the aggregate available capacity for the given resource 48 by the corresponding resource allocation 56 or resource utilization 58 from the demand profile 54. The overall available capacity in spare VMs 70 and the primary constraint 74 are typically based on the lowest value of the available capacity in spare VMs by resource.

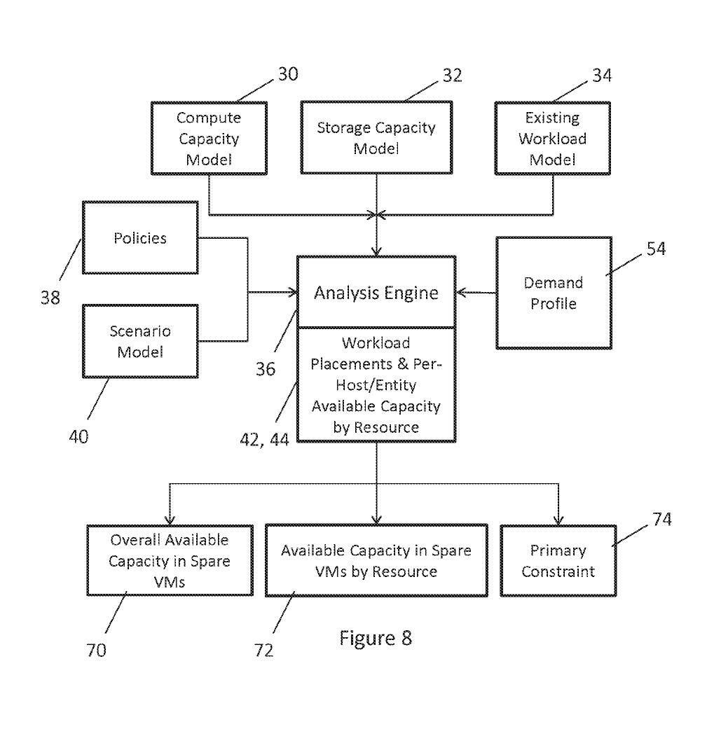

FIG. 8 illustrates a more accurate method for computing the available capacity in spare VMs 70, 72 for a given demand profile 54. In contrast to the method described in FIG. 7, this method is based on the per-host/entity available capacity per resource 44 instead of the aggregate available capacity per resource 48. Specifically, the available capacity in spare VMs for each resource is first computed on a per-host/entity basis. The available capacity in spare VMs by resource on each host is then summed for all the hosts and entities to obtain the available capacity in spare VMs 72 by resource for the infrastructure group.

The analysis method described in FIG. 8 yields a more accurate result than the method described in FIG. 7 since it accounts for the fact that the available capacity exists in discrete entities (e.g. hosts and storage entities). In contrast, the method described in FIG. 7 which uses the aggregate available capacity per resource 48 assumes that the available capacity in the infrastructure group is contiguous.

The computation of available capacity in spare VMs 70, 72 based on the per-host/entity available capacity per resource 44 tends to be more computationally expensive than the computation based on the aggregate available capacity by resource 48. As such, the more accurate computation (FIG. 8) can be used when accuracy in the analysis results is important, whereas the less expensive computation (FIG. 7) can be used when the accuracy of the results is not as important as the computation speed.

In general, the more accurate method for computing the available capacity for spare VMs described in FIG. 8 is intended for a single demand profile 54 and does not apply to aggregate demand profiles 62 based on a set of candidate workloads. Measuring the available capacity on a per-host basis by placing the aggregate demand profiles will tend to result in incorrect lower estimates in the available capacity.

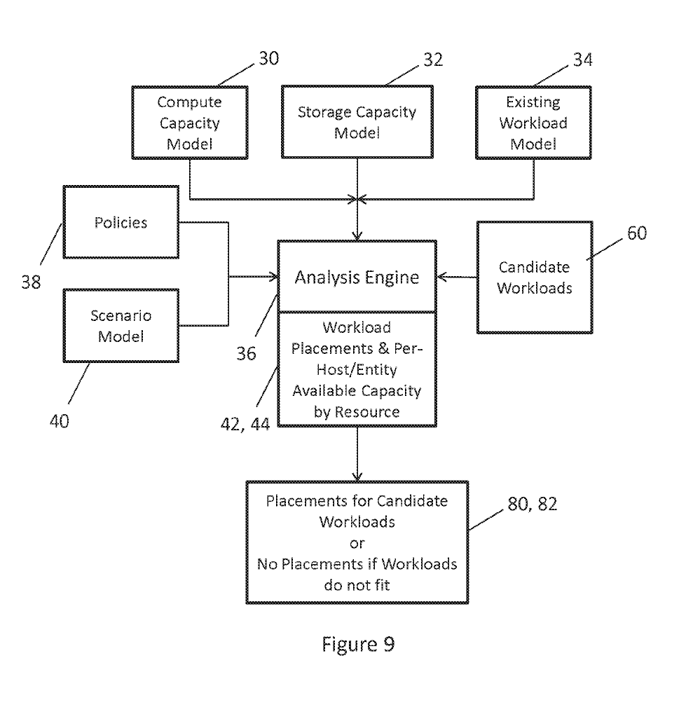

FIG. 9 illustrates a process for validating the available capacity and determining placements for candidate workloads 60 into a given cluster 14. The analysis performed according to FIG. 9 is based on the per-host/entity available capacity per resource 44, and the demand profile 54 of each of the candidate workloads 60. As shown in FIG. 9, the analysis engine 36 attempts to place and reserve capacity for each candidate workload 60 on a specific host and entity. If one or more candidate workloads 60 cannot be placed on a host or entity, the analysis engine 36 assumes that the candidate workloads 60 do not fit (i.e. no placements).

When attempting to place the candidate workloads in a given infrastructure group, the individual workloads are sorted from largest to smallest based on the primary constraint of the infrastructure group 74. The largest workload is then placed on the host with largest amount of available capacity based on the resource corresponding to the primary constraint. If the workload's demand profile fits on the host, decrement the resource allocation and utilization from the available host capacity, and repeat the process for the next largest workload. If all workloads can be placed on a host in the infrastructure group, the analysis engine 36 reports the validated workload placements 80.

If one or more of the candidate workloads cannot be placed in the infrastructure group, the analysis engine 36 undoes any earlier intermediate workload placements and reports that placements for the candidate workloads are not valid 82.

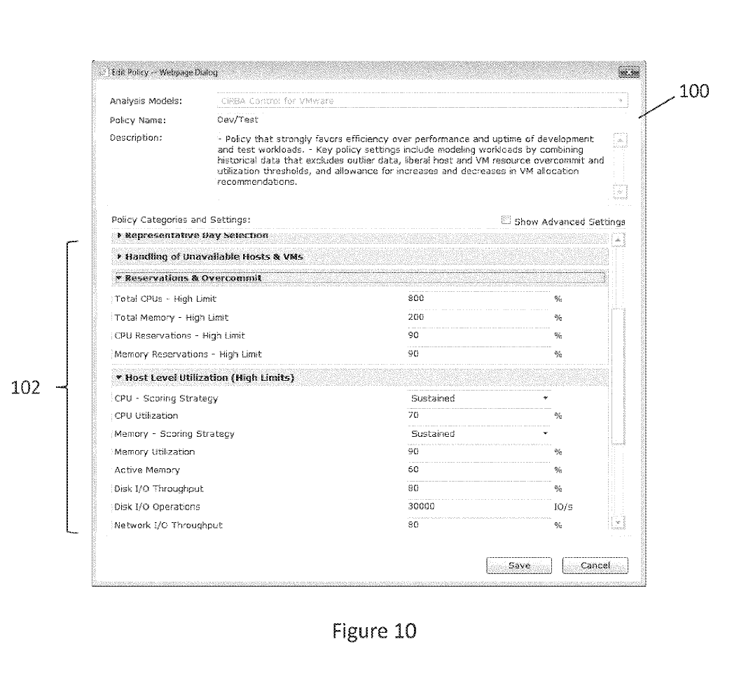

FIG. 10 is a screenshot of an example policy setting user interface (UI) 100 to define management criteria for a given infrastructure group. The user interface 100 includes a number of policy settings 38 that define resource constraints that affect the VM placements and density in the infrastructure group. In the example policy setting UI, users can specify various host-level high limits such as the vCPU/CPU core overcommit (Total CPUs=800%), memory allocated/installed memory (Total Memory=200%), CPU utilization (70%) and Memory Utilization (90%).

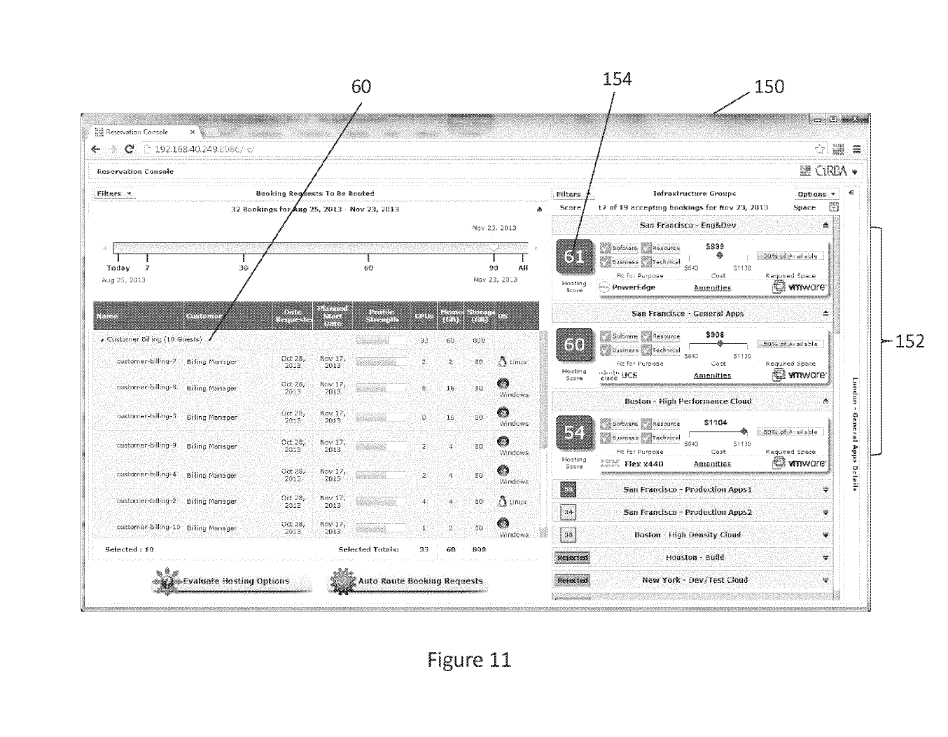

FIG. 11 is a screenshot of an example of a workload routing and reservation console user interface 150. From this UI, users can define and select a given set of candidate workloads 60 to determine the most appropriate infrastructure group or cluster 14 that can host the workloads. The criteria for choosing the appropriate infrastructure group is based on the hosting score 154 which is derived from a combination of the overall available capacity in spare VMs 70, a cost factor and fit for purpose rules that compare workload requirements against the infrastructure capabilities.

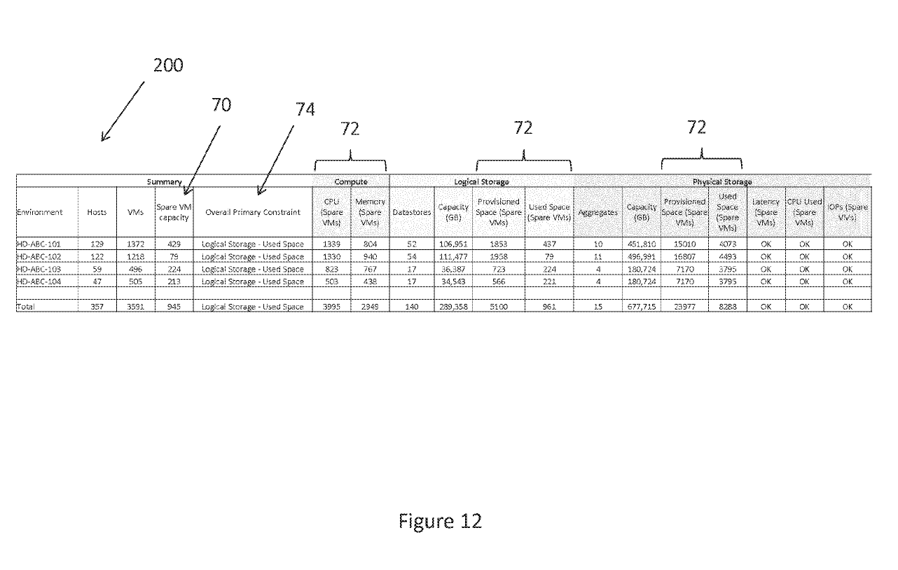

FIG. 12 illustrates an example of a report 200 describing the available capacity in spare VMs for multiple environments. In this report, an environment can be comprised of one or more infrastructure groups. For each environment, the report lists the overall available capacity in spare VMs 70, the primary resource constraint 74, and the available capacity in spare VM by resource 72.

An example of the above-described analyses will now be provided.

For simplicity, this example considers the CPU and memory allocations and capacities as the only resource constraints for the infrastructure group. Other common compute resource constraints such as CPU and memory utilization, and storage related entities and constraints such disk space allocations, disk space usage, etc. are not considered for ease of understanding.

In this example, the compute capacity model 30 is comprised of 7 hosts, each host 16 being configured with 16 CPU cores and 64 GB of memory. The total CPU and memory capacity for the 7 hosts is therefore 112 CPU cores and 448 GB of memory.

The existing workload model 32 is based on 50 VMs 18. The 50 VMs are comprised of 10 of each of the following VM configurations:

| VM Type | Count | Virtual CPUs | Memory |
|---|---|---|---|
| Small | 10 | 1 | 4 |
| Medium-1 | 10 | 2 | 4 |
| Medium-2 | 10 | 4 | 4 |
| Large | 10 | 4 | 8 |
| Extra Large | 10 | 8 | 16 |

The total resource allocations for the 50 VMs are: 190 virtual CPUs (vCPUs) and 360 GB of memory. On average, the existing VMs have a configuration of 3.8 vCPUs (190/50) and 7.2 GB of memory (360/50).

The policy settings 38 related to host-level CPU and memory resource allocation constraints are:
200% high limit for the overcommit ratio of vCPUs to CPU cores
100% high limit for memory allocation to memory capacity.

As such, the aggregate capacity of the cluster is 224 vCPUs and 448 GB of memory.

The traditional measure of aggregate available capacities per resource can be computed by subtracting the aggregate workload allocations from the aggregate resource capacities:

Available vCPU capacity=224−190=34vCPUs

Available Memory capacity=448−360=88 GB

Alternatively, these traditional aggregate available capacities per resource can be expressed as a percentage by dividing the available capacity by the total capacity.

% Available vCPUs capacity=34vCPUs/224vCPU=15%

% Available Memory capacity=88 GB/448 GB=20%

Based on the primary resource constraint of vCPUs, the additional average sized VMs that can be added to the infrastructure group based on pro-rating the current number of VMs and the available capacity can be computed as follows:

Maximum VMs=50VMs*100%/(100%−15%)=58.8=58VMs

Additional VMs=58−50=8VMs

The following table lists an example set of workload placements 42 of the 50 existing VMs on the hosts H1 to H7. The number of VMs of a specific configuration placed on each host listed in the table. For example, 1 medium-1 VM, 1 large and 2 extra large VMs are running on host H1.

| VM Type | H1 | H2 | H3 | H4 | H5 | H6 | H7 | Total |
|---|---|---|---|---|---|---|---|---|
| Small | 0 | 2 | 1 | 0 | 7 | 0 | 0 | 10 |
| Medium-1 | 1 | 1 | 2 | 2 | 2 | 2 | 0 | 10 |
| Medium-2 | 0 | 2 | 1 | 2 | 1 | 1 | 3 | 10 |
| Large | 1 | 1 | 1 | 3 | 1 | 3 | 0 | 10 |
| Extra Large | 2 | 2 | 2 | 1 | 1 | 1 | 1 | 10 |
| Total VMs | 4 | 8 | 7 | 8 | 12 | 7 | 4 | 50 |

This is an example of a current VM placements scenario where the workloads are not balanced across the hosts nor are they optimized. This set of workload placements 42 will be used as the basis for the remainder of the examples for computing the available capacity-related metrics for the infrastructure group.

The following table lists various resource capacity metrics associated with each host. The metrics include the allocated vCPUs and allocated memory which represent the total vCPUs and memory allocations of the VMs placed on the respective hosts. For example, host H1 with the 4 VMs has a total of 2+4+8+8=22 vCPUs, based on the vCPU allocations of the 4 VMs.

| Capacity Metrics | H1 | H2 | H3 | H4 | H5 | H6 | H7 | Total |
|---|---|---|---|---|---|---|---|---|
| Allocated vCPUs | 22 | 32 | 29 | 32 | 27 | 28 | 20 | 190 |
| Allocated Memory | 44 | 60 | 56 | 56 | 64 | 52 | 28 | 360 |

On a per-host basis, the capacity is 32 vCPUs and 64 GB of memory based on the host capacity and the policy limits. These host-level resource capacity limits are useful for determining whether how many VMs can be placed on the host, and whether the host is constrained. Based on the per-host resource capacity limits, the hosts H1, H3, H6 and H7 are not constrained while the hosts H2, H4 and H5 are constrained.

The following table lists the per-host available capacity by resource 44 as well as the per-host stranded capacity by resource. The aggregate available capacity 48 and stranded capacity by resource 46 are also shown in the Total column.

| Capacity Metrics | H1 | H2 | H3 | H4 | H5 | H6 | H7 | Total |
|---|---|---|---|---|---|---|---|---|
| Available vCPUs | 10 | — | 3 | — | — | 4 | 12 | 29 |
| Available Memory | 20 | — | 8 | — | — | 12 | 36 | 76 |
| Stranded vCPUs | — | — | — | — | 5 | — | — | 5 |
| Stranded Memory | — | 4 | — | 8 | — | — | — | 12 |

The aggregate available capacity by CPU and memory resources 48 from the unconstrained hosts (H1, H3, H6, H7) are 29 vCPUs and 76 GB of memory. The aggregate stranded CPU and memory resources 46 from the constrained hosts (H2, H4, H5) are 5 vCPUs and 12 GB of memory. It may be noted that the sum of the available and stranded capacity is equal to the total traditional available capacity.

For this example it is assumed that the demand profiles 54 are based on the Medium-1 (2 vCPUs, 4 GB memory) and Medium-2 (4 vCPUs, 4 GB memory) VM configurations.

Based on the aggregate available capacity by resource 48 (29 vCPUs and 76 GB memory), the spare VM capacity for these demand profiles are shown below:

| | Available | Available | | |
|---|---|---|---|---|
| | Capacity | Capacity | Overall Available | Primary |
| Demand | by vCPUs | by Memory | Capacity | Resource |
| Profile | (Spare VMs) | (Spare VMs) | (Spare VMs) | Constraint |
| Medium-1 | 14 | 19 | 14 | vCPUs |
| Medium-2 | 7 | 19 | 7 | vCPUs |

The available capacity in spare VMs per resource 72 is computed by dividing the aggregate capacity per resource 48 by the corresponding resource allocation 56 of the demand profile 56.

For example, for the medium-1 VMs, the available capacity in spare VMs based on vCPUs is FLOOR(29 vCPUs/2 vCPUs/VM)=14 VMs. Similarly, the available capacity in spare VMs based on memory is FLOOR(76 GB/4 GB/VM)=19 VMs. The lesser of the two values reflects the overall available capacity in spare VM capacity (14) and the primary constraint (vCPUs).

The table below can be considered in this example for determining the available capacity in spare VMs based on per-host capacity. This table lists the per-host available capacity for the vCPUs and memory resources 44.

| Capacity Metric | H1 | H2 | H3 | H4 | H5 | H6 | H7 |
|---|---|---|---|---|---|---|---|
| Available vCPUs | 10 | — | 3 | — | — | 4 | 12 |
| Available Memory | 20 | — | 8 | — | — | 12 | 36 |

The available capacity in spare VMs for the cluster 14 is determined by dividing the per-host available capacity for each resource constraint by the corresponding resource allocation from the demand profile.

For example, on H1 with 10 vCPUs and 20 GB memory of available capacity, 5 medium-1 VMs can be accommodated based on:

10vCPUs/2vCPUs/VM=5VMs

20 GB/4 GB/VM=5VMs.

Similarly, on H1, 2 medium-2 VMs can be accommodated based on:

10vCPUs/4vCPUs/VM=2.5VMs

20 GB/4 GB/VM=5VMs.

And taking the lesser of the spare VMs (2.5) and taking the floor value (2).

Repeating the above calculation for the remaining hosts with available capacity in the infrastructure group yields the results below.

| VM Type | H1 | H2 | H3 | H4 | H5 | H6 | H7 | Total |
|---|---|---|---|---|---|---|---|---|
| Medium-1 (Spare VMs) | 5 | — | 1 | — | — | 2 | 6 | 14 |
| Medium-2 (Spare VMs) | 2 | — | 0 | — | — | 1 | 3 | 6 |

The overall available capacity in spare VMs 70 is then computed from the sum of the available capacity in spare VMs on each of the hosts in the cluster. As shown above, 14 Medium-1 spare VMs can fit which is the same estimate as when computed from the aggregate available capacity. In the case of the Medium-2 demand profile, 6 spare VMs can fit, which is less than the 7 estimated using the aggregate available capacity. The available capacity in spare VMs computed on a per-host basis is more accurate result since it does not assume that the available capacity is contiguous across the hosts.

For determining the candidate workloads 60, in this example it is assumed that there is a set of 5 candidate workloads comprised of: 2 small VMs, 2 medium-2 VMs and 1 large VM.

| | | vCPUs | Memory per VM |
|---|---|---|---|
| VM Type | Count | per VM | (GB) |
| Small | 2 | 1 | 4 |
| Medium-2 | 2 | 4 | 4 |
| Large | 1 | 4 | 8 |

The aggregate demand profile for the set of candidate workloads is 14 vCPUs and 24 GB of memory. Recalling the aggregate available capacity by resource 48 are 29 vCPUs and 76 GB of memory, the aggregate available capacity in spare VMs by resource 72 are:

Available Capacity in Spare VMs based on vCPUs=29vCPUs/14vCPUs=2

Available Capacity in Spare VMs based on memory=76 GB/24 GB=3

Based on the above results, the overall Available Capacity in Spare VMs 70 is 2 and the primary constraint 74 is the vCPU resource.

The placements can now be validated to ensure that the candidate workloads 60 fit in the cluster 14, by verifying the placements of the 5 individual VMs 18.

A suitable placement method is as follows:
Sort VMs from largest to smallest
Sort hosts from host with most available capacity to least
Try to place VM on host with most available capacity
If it does not fit, try next host in sorted list
If VM cannot be placed, abort and declare that one or more candidate workloads cannot be placed 82
If VM can be placed, reserve the capacity on the host
Process the next VM until all VMs have been placed.

Based on the example candidate workloads and cluster, the VMs can be placed on the following hosts 80:

| | | Available | Available |
|---|---|---|---|
| | | vCPUs | Memory |
| | Host | on host after | on host after |
| Candidate Workload | Placement | placement | placement |
| Large (4 vCPUs, 8 GB) | H7 | 8 | 28 |
| Medium-2 (4 vCPUs, 4 GB) | H7 | 4 | 24 |
| Medium-2 (4 vCPUs, 4 GB) | H1 | 6 | 16 |
| Small (1 vCPU, 4 GB) | H7 | 3 | 20 |
| Small (1 vCPU, 4 GB) | H7 | 2 | 16 |

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the analysis engine 36, any component of or related thereto or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of determining available capacity for each resource for each capacity entity of an infrastructure group with existing workloads, the method comprising:
determining one or more workload placements of one or more workload demand entities on one or more capacity entities in the infrastructure group; and
computing an available capacity for each resource for each capacity entity in the infrastructure group, according to the workload placements.

2. The method of claim 1, wherein all free resources on a particular capacity entity are classified as available capacity when none of the resources is constrained on the particular capacity entity.

3. The method of claim 1, wherein all free resources on a particular capacity entity are classified as not available when one or more resources are constrained on a particular capacity entity.

4. The method of claim 1, further comprising determining at least one of:
a capacity model comprising one or more capacity entities, each entity representing at least one of: one or more compute resources, one or more storage resources, and one or more network-related resources, consumable by workloads running in the infrastructure group; and
a workload model comprising one or more workload demand entities, each entity representing at least one of: one or more compute resources, one or more storage resources, and one or more network-related resources, required by the workloads running in the infrastructure group.

5. The method of claim 1, wherein the one or more workload placements are determined according to at least one policy specifying at least one criterion for managing the infrastructure group, and a scenario model specifying a use case to be modeled that impacts the workload placements, wherein the available capacity for each resource for each capacity entity are computed according to at least one policy criterion.

6. The method of claim 1, further comprising determining aggregate available capacity for each resource for an infrastructure group, using the available capacity for each resource for each capacity entity.

7. The method of claim 6, further comprising determining available capacity for each resource for an infrastructure group for a given demand profile based on the aggregate available capacity for each resource.

8. The method of claim 6, further comprising determining a primary resource constraint of the infrastructure group using the aggregate available capacity for each resource.

9. The method of claim 6, further comprising determining a primary resource constraint for the infrastructure group for a given demand profile based on the aggregate available capacity for each resource.

10. The method of claim 1, further comprising determining available capacity for each resource for an infrastructure group for a given demand profile based on the available capacity for each resource for each capacity entity.

11. The method of claim 1, further comprising determining whether a set of candidate workloads can fit in the infrastructure group using the available capacity per resource per capacity entity to evaluate the placements of the set of candidate workloads on the capacity entities of the infrastructure group.

12. The method of claim 11, further comprising determining that a set of candidate workloads fits in the infrastructure group when all candidate workloads can be placed on the capacity entities of the infrastructure group.

13. The method of claim 11, further comprising determining that a set of candidate workloads do not fit in an infrastructure group when one or more candidate workloads cannot be placed on the capacity entities of the infrastructure group.

14. A computer readable medium comprising computer executable instructions for determining available capacity for each resource for each capacity entity of an infrastructure group with existing workloads, the computer executable instructions comprising instructions for:
determining one or more workload placements of one or more workload demand entities on one or more capacity entities in the infrastructure group; and
computing an available capacity for each resource for each capacity entity in the infrastructure group, according to the workload placements.

15. A method of determining stranded capacity for each resource for each capacity entity for an infrastructure group with existing workloads, the method comprising:
determining one or more workload placements of one or more workload demand entities on one or more capacity entities in the infrastructure group; and
computing a stranded capacity for each resource for each capacity entity in the infrastructure group, according to the workload placements.

16. The method of claim 15, wherein stranded capacity is determined when one or more resources are constrained on a particular capacity entity by classifying a free capacity of all other resources on the particular capacity entity as stranded capacity.

17. The method of claim 15, further comprising determining at least one of:
a capacity model comprising one or more capacity entities, each entity representing at least one of: one or more compute resources, one or more storage resources, and one or more network-related resources, consumable by workloads running in the infrastructure group; and
a workload model comprising one or more workload demand entities, each entity representing at least one of: one or more compute resources, one or more storage resources, and one or more network-related resources, required by the workloads running in the infrastructure group.

18. The method of claim 15, wherein the one or more workload placements are determined according to at least one policy specifying at least one criterion for managing the infrastructure group, and a scenario model specifying a use case to be modeled that impacts the workload placements, wherein the stranded capacity for each resource for each capacity entity are computed according to at least one policy criterion.

19. The method of claim 15, further comprising determining aggregate stranded capacity for each resource for an infrastructure group, using the stranded capacity for each resource for each capacity entity.

20. A computer readable medium comprising computer executable instructions for determining stranded capacity for each resource for each capacity entity for an infrastructure group with existing workloads, the computer executable instructions comprising instructions for:
determining one or more workload placements of one or more workload demand entities on one or more capacity entities in the infrastructure group; and
computing a stranded capacity for each resource for each capacity entity in the infrastructure group, according to the workload placements.
